(19) United States
(12) Patent Application Publication
(10) Pub. No.: US 2013/0162105 A1
(43) Pub. Date: Jun. 27, 2013

(54) SYSTEM FOR ELECTRIC POWER GENERATION AND A METHOD FOR POWER GENERATION WITH THE SAID SYSTEM

(71) Applicant: Nickolay Timofeevich GOYDIN, Saint Petersburg (RU)

(72) Inventor: Nickolay Timofeevich GOYDIN, Saint Petersburg (RU)

(21) Appl. No.: 13/549,549

(22) Filed: Jul. 16, 2012

Related U.S. Application Data
(60) Provisional application No. 61/578,340, filed on Dec. 21, 2011.

(51) Int. Cl. H02N 2/18

(52) U.S. Cl. 310/339

(57) ABSTRACT

The invention relates to the method and device for transforming mechanical stress power into electric power and may be used to create an additional power supply source for the power supply system of a submarine vessel. Proposed system for electric power generation comprises a basis, piezoelectric transformers mounted on the said basis and means for mechanical load application on the transformers, where the piezoelectric transformers are provided on the structural elements of the submarine vessel, which elements are not rigidly connected to the hull of the submarine vessel and have an operative position, where the interaction with the hull of submarine vessel is possible, so that seawater pressure is propagated to the piezoelectric transformers through the hull of submarine vessel in case of the change in submersion depth of the said vessel.

### CROSS-REFERNCE TO RELATED APPLICATIONS

This application claims priority from U.S. 61/578,340 of Dec. 21, 2011. The content of this application is hereby incorporated by reference in it entirety.

### FIELD OF THE INVENTION

The invention relates to the method and device for transforming mechanical stress power into electric power and may be used as an additional power supply source for the power supply system of a submarine vessel.

### BACKGROUND OF THE INVENTION

During long-term underwater navigation the submarine vessel, for example a submarine, constantly experience environmental pressure of the sea water (FIG. 1 and FIG. 2). A change in depth of submersion causes deformation of the hull and induces variation of general linear dimensions. This phenomenon was illustrated in the movie [symbol] Down Periscope [symbol] , ( [symbol] Down Periscope [symbol] , released in 1996, USA, 26-30 min).

Said mechanical pressure is considered in the construction of the submarine and major elements are mounted so as to avoid intolerable strains.

For example, as shown on the FIG. 3, decks are supported by supporting brackets and do not experience pressure from the hull as the said decks are not rigidly connected to the submarine hull. As a result, relative position of the deck to the hull is changed. This design feature of the submarine vessel may be used as a basis to create an electric power source, based on piezoelectric cells.

It is known, that piezoelectric transformers may be used for creation of power supply sources. For example, power generation systems are known, where mechanical load of piezoelectric transformers is caused by moving means of transportation.

A device for power generation selected as a prototype model is known (U.S. Pat. No. 7,830,071, Published 9 Nov 2010). The known device comprises a basis, piezoelectric transformers, mounted thereon and means for mechanical load application on piezoelectric transformers. The transformers are provided under the road bed, serving as a medium for mechanical load application, and electrical power is generated when means of transportation interact with the road bed in the points, where piezoelectric transformers are provided. However, the device for electric power generation is not known, which device comprises piezoelectric transformers, which are provided on the structural elements of the submarine vessel and which experience the pressure of the seawater pressure force in case of change in the depth of submersion of the submarine vessel.

The method for electric power generation selected as a prototype method is also known (U.S. Pat. No. 7,830,071, Published 9 Nov 2010). According to the prior method, the piezoelectric transformers are provided on the base, loaded mechanically and electrical power is generated thereby. In this case piezoelectric transformers are provided under the road bed and electric power is generated when means of transportation transit over the point, where the said piezoelectric transformers are provided.

However, the method for electric power generation with piezoelectric transformers, which are provided on the structural elements of the submarine vessel and are experiencing the pressure of the seawater pressure force when the depth of submersion of submarine vessel changes, is not known.

### BRIEF SUMMARY OF THE INVENTION

The object of the present invention is to create a system and a method for electric power generation with usage of piezoelectric transformers, which are provided on the structural elements of the submarine vessel and are experiencing the pressure of the seawater pressure force in case of the change in the depth of submersion of the submarine vessel.

Technical result, achieved upon attaining the object of the invention, lies in the promotion of performance of the system and method for power generation and the expansion of scope of application of the piezoelectric transformers, enabling their operation in case said transformers are provided on the structural elements of the submarine vessel.

Said technical result is achieved due to creation of the system for electric power generation, comprising a base, piezoelectric transformers, mounted thereon and means for mechanical load application on piezoelectric transformers, where the piezoelectric transformers are provided on the structural elements of the submarine vessel, which elements are not rigidly connected to the hull of the submarine vessel and have an operative position, where the interaction with the hull of submarine vessel is possible, so that seawater pressure is propagated to the piezoelectric transformers through the hull of submarine vessel in case of the change in submersion depth of the said vessel.

Piezoelectric transformers may be mounted on the vessel deck or on the structural elements, rigidly connected to the deck.

Piezoelectric transformers may have an inoperative position, in which they are retracted from the hull of submarine vessel, and the system may further comprise means for switching the position of piezoelectric transformers from operative position to inoperative position.

Every one of piezoelectric transformers may comprise at least two piezoelectric cells, mounted on one base and provided in one casing, each of them having a spring shock absorber, designed with a possibility to interact with the hull of the vessel, and the said shock absorbers have various rigidity and length.

Means for switching the position of piezoelectric transformers from the operative position to inoperative position may be designed as guide rails, and piezoelectric transformers may be designed with a possibility to move along the said guide rails.

Moreover, the technical result of the invention is achieved due to the method of electric power generation, which method includes steps of placing piezoelectric transformers on the base, applying mechanical load to the transformers and receiving electric power, wherein piezoelectric transformers are provided on the structural elements of the submarine vessel, which are not rigidly connected to the hull, said piezoelectric transformers are latched in the operative position, enabling the interaction between piezoelectric transformers and hull of the submarine vessel, and propagate seawater pressure to piezoelectric transformers through the hull of the submarine vessel in case of a change in depth of submersion of the submarine vessel.

Piezoelectric transformers may be provided on the deck of submarine vessel or on structural elements of submarine vessel, not connected rigidly to the deck.

Position of piezoelectric transformers may be switched to inoperative position by retracting them from the hull of the submarine vessel and latching them in this position.

### BRIEF DESCRIPTION OF THE SEVERAL VIEWS OF THE DRAWINGS

A detailed description of the proposed invention is provided below with reference to figures, wherein

FIG. 1 schematically shows the relation between the seawater pressure on the hull of submarine vessel and depth of submersion of the said submarine vessel;

FIG. 2 shows the chart illustrating influence of seawater pressure on the hull of submarine vessel.

FIG. 3 schematically shows the cross section of submarine vessel.

FIG. 4 schematically shows a piezoelectric transformer and its position regarding structural elements of a submarine vessel.

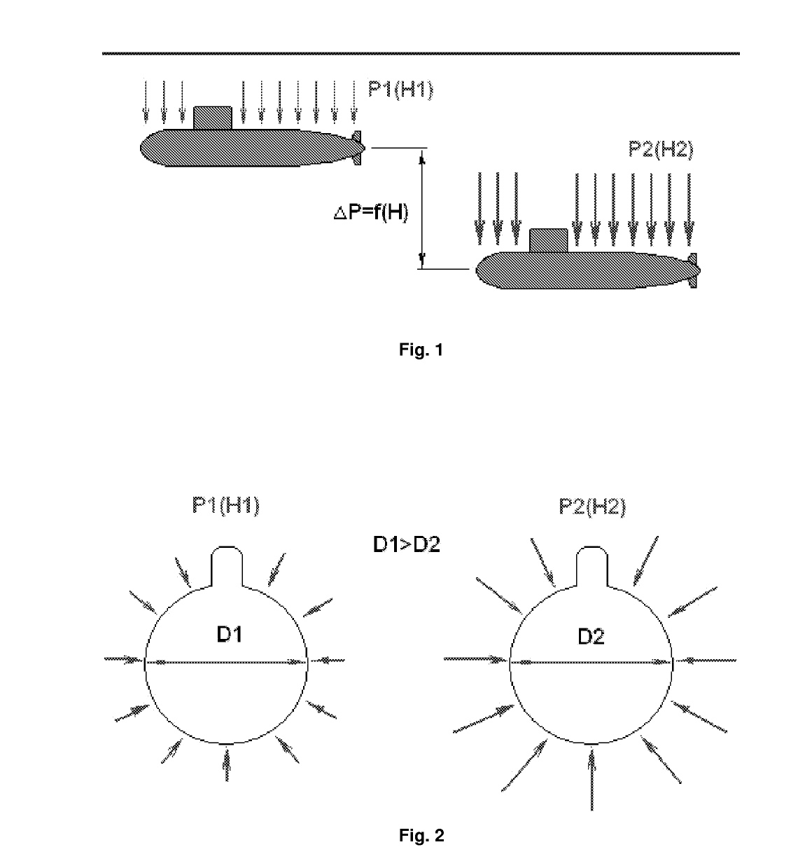

### DETAILED DESCRIPTION OF THE INVENTION

Proposed system for electric power generation comprises a base 3, piezoelectric transformers 1 (FIG. 4), mounted on the said base 3 and means for mechanical load application on the transformers 1. Structural elements of a submarine vessel, which are not rigidly connected to a hull 2 are used as a base.

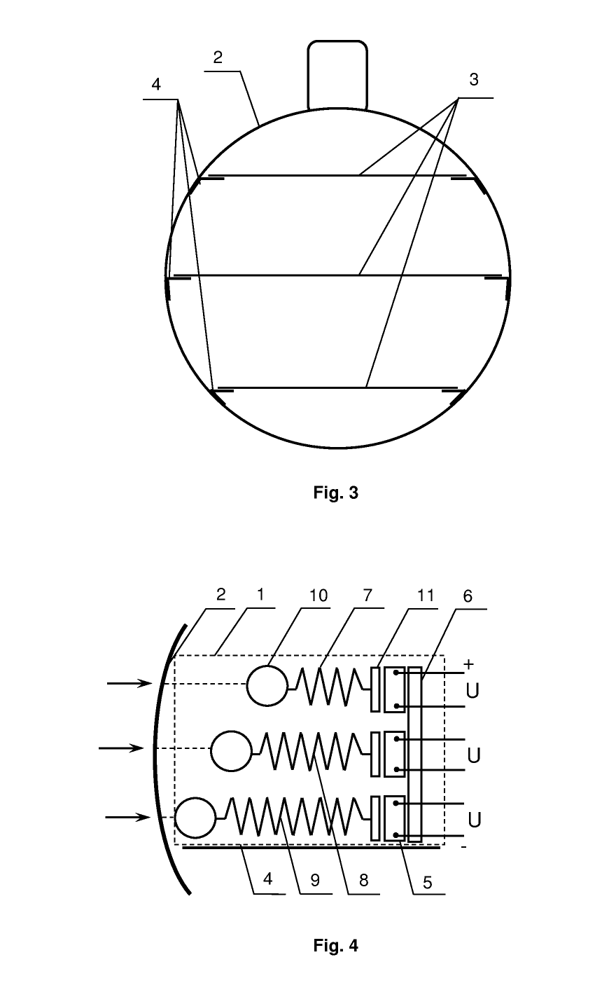

Deck 3 may serve as this structural element, which lies on the brackets 4 and is not rigidly connected to the hull 2 (FIG. 3 and FIG. 4). Moreover, transformers 1 may be provided on the structural elements of the vessel, which are not rigidly connected to the deck 3 (not shown on figures).

Transformers 1 have an operative position, where the interaction with the hull 2 is possible, so that seawater pressure is propagated through the hull 2 to the transformers in case of change in the depth of submersion of submarine vessel. In this case the hull 2 serves as means for mechanical load application on the transformers 1.

In the proposed system means for switching the position of transformers 1 from operative position to inoperative position, in which the said transformers are retracted from the hull 2 and the interaction is disabled, may be provided. These means may be arranged as guide rails (not shown on figures). The said transformers 1 may be designed with a possibility to be moved along, for example, manually, along the said rails.

Each of transformers 1 may comprise several piezoelectric cells 5 (FIG. 4), provided on the shared basis 6. The appropriate quantity of piezoelectric cells 5 in the context of maintainability amount to two or three piezoelectric cells. Moreover, each transformer 1 may comprise spring shock absorbers 7, 8 and 9, interacting with piezoelectric cells 5 and with the hull 2 of the vessel and propagating seawater pressure to the piezoelectric cell 5 through the hull 2 of the vessel in case of change in depth of submersion of the vessel. Each of the shock absorbers 7, 8 and 9 may comprise a ram 10 on one end for interaction with the hull 2, for example a spherical ram, allowing effective removal of the horizontal component of the pressure force applied to the hull 2. On the other end of each of the shock absorbers 7, 8 and 9 a plate may be provided, placed adjacently to the piezoelectric cell 5 and enabling pressure propagation from the hull 2 of the vessel.

Shock absorbers 7, 8 and 9 have various rigidity and length. The longest shock absorber 9 (FIG. 4) have the smallest rigidity, and the shortest shock absorber 7 have the largest rigidity. The length of shock absorbers 7, 8 and 9 defines position of corresponding rams relative to the hull 2 of the vessel. For example, a ram of the shock absorber 9 is positioned so as to be the nearest to the hull 2, and a ram of the shock absorber 7 is positioned so as to be the outermost to the hull 2. This arrangement of transformers 1 allows stepwise activation of piezoelectric cells 5 with submersion of the submarine vessel and increasing seawater pressure.

Selection of shock absorbers length-to-rigidity ratio may be conducted experimentally. Pressure applied to piezoelectric cells is adjusted by changing the depth of immersion of the submarine vessel.

The present arrangement of transformers assists to avoid premature failure of piezoelectric cells.

Transformers 1 may be distributed across the deck in the points allowing installation of the said transformers.

Electric charges generated on the electrodes of piezoelectric cells of each of transformers 1 are further supplied to electric power storage systems, which may be designed as independent devices or may be included in the vessel power system. Power converters, allowing control of stored electric power, for example, as DC, may also be provided

The proposed method for electric power generation includes following steps. Transformers 1 are provided on the structural elements of the submarine vessel, which are not rigidly connected to the hull 2 of the submarine vessel, said piezoelectric transformers are latched in the operative position, enabling the interaction between piezoelectric transformers and a hull 2 of the submarine vessel in case of a change in depth of submersion of the submarine vessel the hull 2 experiences seawater pressure, shown with arrows on FIG. 4, leading to deformation of the hull 2. Applied pressure is propagated to transformers 1 through the hull 2, and electric charges are generated on the electrodes of said transformers, which are further supplied to the power sink device.

Transformers 1 may be provided both on the deck 3 of the vessel and on the structural elements, which are not rigidly connected to the deck.

Transformers 1 may be switched to the inoperative position when needed.

Application of the proposed system allows to obtain an additional power supply source, for the operation of which surfacing of the submarine vessel is not required.

Moreover, the proposed system may be applied upon a staff decision, the staff sets up a frequency of required changes in depth of submersion of the submarine vessel.

Dimensions and costs of elements of the proposed system allow performing replacement of damaged elements on the routine basis.

I claim:

1. System for electric power generation, comprising a basis, piezoelectric transformers, provided thereon and means for mechanical load application on piezoelectric transformers, wherein the piezoelectric transformers are provided on the structural elements of the submarine vessel, which are not rigidly connected to the hull of the submarine vessel and have an operative position, where the interaction with the hull of submarine vessel is possible, so that seawater pressure is propagated to the piezoelectric transformers through the hull of submarine vessel in case of the change in submersion depth of the said vessel.

2. System according to claim 1, wherein piezoelectric transformers are provided on the deck of the submarine vessel.

3. System according to claim 1, wherein piezoelectric transformers are provided on the structural elements, which are not rigidly connected to the deck of the submarine vessel.

4. System according to claim 2, wherein piezoelectric transformers have an inoperative position, in which they are retracted from the hull of submarine vessel, and the system may further comprise means for switching the position of piezoelectric transformers from operative position to inoperative position.

5. System according to claim 3, wherein piezoelectric transformers have an inoperative position, in which they are retracted from the hull of submarine vessel, and the system may further comprise means for switching the position of piezoelectric transformers from operative position to inoperative position.

6. System according to claim 1, wherein every one of piezoelectric transformers may comprise at least two piezoelectric cells, mounted on one basis and provided in one casing, each of them having a spring shock absorber, designed with a possibility to interact with the hull of the vessel, and the said shock absorbers have various rigidity and length.

7. System according to claim 6, wherein means for switching the position of piezoelectric transformers from the operative position to inoperative position may be designed as guide rails, and piezoelectric transformers may be designed with a possibility to move along the said guide rails.

8. Method of electric power generation, which method includes steps of placing piezoelectric transformers on the basis, applying mechanical load to the transformers and receiving electric power, wherein piezoelectric transformers are provided on the structural elements of the submarine vessel, which are not rigidly connected to the hull, said piezoelectric transformers are latched in the operative position, enabling the interaction between piezoelectric transformers and hull of the submarine vessel, and propagate seawater pressure to piezoelectric transformers through the hull of the submarine vessel in case of a change in depth of submersion of the submarine vessel.

9. Method according to the claim 8, wherein piezoelectric transformers are provided on the deck of the submarine vessel.

10. Method according to the claim 8, wherein piezoelectric transformers are provided on the structural elements of the submarine vessel, which are not rigidly connected to the deck.

11. Method according to the claim 8, wherein piezoelectric transformers are switched to inoperative position by retracting them from the hull of the submarine vessel and latching them in this position.
